(19) United States
(12) Patent Application Publication
(10) Pub. No.: US 2026/0203382 A1
(43) Pub. Date: Jul. 16, 2026

(54) ELECTRONIC DEVICE FOR FORMING P2P GROUP AND CONTROL METHOD THEREFOR

(71) Applicant: Samsung Electronics Co., Ltd., Suwon-si (KR)

(72) Inventor: Sangu SHIM, Suwon-si (KR)

(73) Assignee: Samsung Electronics Co., Ltd., Suwon-si (KR)

(21) Appl. No.: 19/563,839

(22) Filed: Mar. 11, 2026

Related U.S. Application Data
(63) Continuation of application No. PCT/KR2024/012878, filed on Aug. 28, 2024.

(30) Foreign Application Priority Data
Oct. 19, 2023 (KR) 10-2023-0140302

(51) Int. Cl. G06F 21/31

(52) U.S. Cl. CPC G06F 21/31

(57) ABSTRACT

An electronic device comprising a communication interface; a memory to store at least one instruction; and a processor. The processor is configured to: based on detecting a first event to form a P2P group with an external device through a first communication frequency, receive, from the external device, first authentication information to form the P2P group through the first communication frequency and second authentication information for forming the P2P group through a second communication frequency; form the P2P group through the first communication frequency by using the first authentication information; and based on detecting a second event to form the P2P group with the external device through the second communication frequency, form the P2P group through the second communication frequency by using the second authentication information received based on the first event.

### CROSS-REFERENCE TO RELATED APPLICATION

This application is a continuation application, under 35 U.S.C. § 111(a), of international application No. PCT/KR2024/012878, filed Aug. 28, 2024, which claims priority under 35 U.S.C. § 119 to Korean Patent Application No. 10-2023-0140302, filed Oct. 19, 2023, the disclosures of which are incorporated herein by reference in their entireties.

### TECHNICAL FIELD

This disclosure relates to an electronic device and a control method thereof, and more particularly, to an electronic device forming a peer-to-peer (P2P) group with an external electronic device, and a control method thereof.

### BACKGROUND ART

With the advancement in the electronic technologies, various types of electronic devices have been developed. In particular, electronic devices enabling a Wi-Fi P2P connection have recently been developed.

The Wi-Fi P2P technology suggested by the Wi-Fi Alliance involves allowing devices providing a Wi-Fi function to be connected directly and perform communication even without an access point, as well as providing compatibility with an existing Wi-Fi. A direct communication function between devices may be similar to that of Bluetooth, but in terms of a transmission range and a data transmission speed, the Wi-Fi P2P is advantageous over Bluetooth and rapidly substituted for Bluetooth. For example, Bluetooth 4.0 as the latest Bluetooth standard supports a transmission range of a maximum of up to 100 m and a transmission speed of a maximum of 24 Mbps, while the Wi-Fi Direct supports a transmission range of a maximum of up to 200 m and a transmission speed of a maximum of 300 Mbps or greater.

In the case where the Wi-Fi P2P is used, data, files and the like may be rapidly shared by two devices, and the screen of one device may be displayed on the screen of another through an application program such as screen mirroring, DLNA and the like.

Recently, a frequency band of 6 GHz has been newly adopted based on Wi-Fi spec 802.11 6E. Meanwhile, since authentication information for forming a P2P group in a frequency band of 2.4 Ghz or 5 Ghz differs from authentication information for forming a P2P group in a frequency band of 6 GHz, new authentication information needs to be generated, to form a P2P group in the 6 GHz frequency band with an external device where a P2P groups is previously formed in the 2.4 Ghz or 5 GHz frequency band, causing inconvenience.

### DISCLOSURE OF INVENTION

### Technical Problem

An electronic device according to one or more embodiments incudes a communication interface; memory storing at least one instruction; and a processor connected with the memory to control the electronic device. The processor receives, from the external device, based on a first event to form a P2P group with an external device through a first communication frequency being detected, first authentication information to form the P2P group through the first communication frequency and second authentication information to form the P2P group through a second communication frequency forms the P2P group through the first communication frequency by using the first authentication information, and forms, based on a second event to form the P2P group with the external device through a second communication frequency being detected, the P2P group through the second communication frequency by using the second authentication information received based on the first event.

A control method of an electronic device according to one or more embodiments includes receiving from an external device, based on a first event to form a P2P group with the external device through a first communication frequency being detected, first authentication information to form the P2P group through the first communication frequency and second authentication information to form the P2P group through a second communication frequency; forming the P2P group through the first communication frequency by using the first authentication information; and forming, based on a second event to form the P2P group with the external device through a second communication frequency being detected, the P2P group through the second communication frequency by using the second authentication information received based on the first event.

In a non-transitory computer-readable recording medium including a program that executes a control method of an electronic device according to one or more embodiments, the method includes receiving from an external device, based on a first event to form a P2P group with the external device through a first communication frequency being detected, first authentication information to form the P2P group through the first communication frequency and second authentication information to form the P2P group through a second communication frequency from the external device; forming the P2P group through the first communication frequency by using the first authentication information; and forming, based on an event to form the P2P group with the external device through a second communication frequency being detected, the P2P group through the second communication frequency by using the second authentication information received based on the first event.

### BRIEF DESCRIPTION OF DRAWINGS

FIG. 1 is a system diagram provided to explain a P2P group system according to one or more embodiments;

FIG. 2 is a block diagram provided to explain a configuration of an electronic device according to one or more embodiments;

FIG. 3 is a flowchart provided to explain a method by which an electronic device performs a provisioning operation for forming a P2P group according to one or more embodiments;

FIG. 4 is a sequence diagram provided to explain a method by which an electronic device performs a provisioning operation for forming a P2P group according to one or more embodiments;

FIG. 5 is a view provided to explain an attribute of an M8 message according to one or more embodiments;

FIGS. 6 and 7 are views provided to explain authentication information according to one or more embodiments; and

FIG. 8 is a flowchart provided to explain a method by which an electronic device forms a P2P group with an external device by using authentication information stored in memory according to one or more embodiments.

### MODE FOR INVENTION

Embodiments of the present disclosure may be modified in various different forms, and may vary. Accordingly, specific embodiments are illustrated in the drawings, and described in detail in the detailed description. However, it is to be understood that the scope of the disclosure is not limited to the specific ones, and embodiments of the disclosure are to be understood as including various modifications, equivalents and/or alternatives of the embodiments set forth herein. In the drawings, like reference numerals may be used to indicate like elements.

In describing the disclosure, in case specific descriptions of known functions or configurations to which the disclosure pertains make the gist of the disclosure unnecessarily vague, detailed descriptions thereof are omitted.

Additionally, the embodiments described hereafter may be modified in various different forms, and it is to be understood that the scope of the technical spirit of the disclosure is not limited to the embodiments. Rather, the embodiments are provided to make the disclosure thorough and complete and to fully convey the technical spirit of the disclosure to those skilled in the art.

Terms set forth herein are merely used to describe a specific embodiment, and are not intended to limit the scope of the right for which protection is sought. Unless explicitly stated otherwise, singular forms include plural forms as well.

In the disclosure, expressions such as “have,” “may have,” “include,” or “may include,” and the like are used to indicate the presence of a corresponding feature (e.g., elements such as a numerical value, a function, an operation, or a part and the like), and do not imply exclusion of the presence of additional features.

In the disclosure, expressions such as “A or B,” “at least one of A or/and B,” or “one or more of A or/and B” and the like may include all possible combinations of the items listed together. For example, “A or B,” “at least one of A and B,” or “at least one of A or B” may refer to all cases including (1) at least one A, (2) at least one B, or (3) both of at least one A and at least one B.

In the disclosure, the expression “1st”, “2nd”, “first”, or “second”, and the like may be used to refer to various elements regardless of their order and/or importance, and may be used merely to differentiate one element from another but not intended to limit the elements.

In the case where one element (e.g., a first element) is referred to as being “(operatively or communicatively) coupled with/to or connected with/to” another element (e.g., a second element), it is to be understood that one element may be connected to another element directly or through yet another element (e.g., a third element).

On the other hand, in the case where one element (e.g., a first element) is referred to as being “directly coupled with/to” or “directly connected with/to” another element (e.g., a second element), it is to be understood that yet another element (e.g., a third element) is not present between one element and another element.

In the disclosure, the expression “configured to . . . (or set to)” may be used interchangeably with, for example, “suitable for . . . ,” “having the capacity to . . . ,” “designed to . . . ,” “adapted to . . . ,” “made to . . . ,” or “capable of . . . ” depending on circumstances. The wording “configured to (or set to)” may not necessarily mean “being specifically designed to . . . ” hardwarewise.

Rather, in a certain situation, the expression “a device configured to . . . ” may mean “being capable of performing” by the device together with another device or other parts. For example, the phrase “a processor configured (or set) to perform A, B and C” may mean an exclusive processor (e.g., an embedded processor) for performing the functions, or a generic-purpose processor (e.g., a CPU or an application processor) capable of performing the functions by executing one or more software programs stored in a memory device.

In relation to the embodiments, the term “module” or “unit” may perform at least one function or operation, and be implemented by hardware or software or by a combination of hardware and software. Additionally, a plurality of “modules” or a plurality of “units” may be integrated into at least one module and be implemented as a processor excluding a “module” or a “unit” that needs to be implemented by specific hardware.

Meanwhile, various elements and regions in the drawings are schematically illustrated. Accordingly, the technical spirit of the disclosure is not limited by relative sizes or distances illustrated in the drawings.

Hereafter, the subject matter of the disclosure is described in detail with reference to the drawings such that those skilled in the art to which the disclosure pertains readily implement the embodiments.

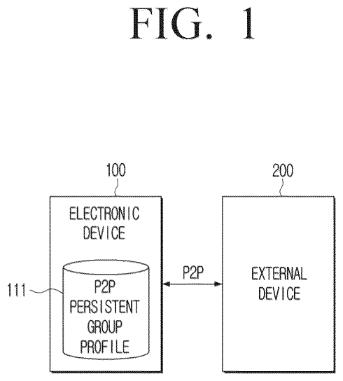

FIG. 1 is a system diagram provided to explain a P2P group system according to one or more embodiments.

An electronic device 100 may form a P2P group with an external device 200. At this time, the electronic device 100 may be a client device constituting a P2P group, while the external device 200 may be an owner device forming a P2P group.

At this time, while the electronic device 100 performs a P2P group operation with the external device 200, the electronic device 100 may perform a provisioning operation for forming the P2P group with the external device 200.

The provisioning operation may mean an operation in which a group owner device and a group client device form a P2P group while exchanging information such as a network key and the like to form the P2P group (or a P2P group) such as Wi-Fi Direct. At this time, an attribute of the P2P group formed between the electronic device 100 and the external device 200 may be determined as one of a temporary group or a persistent group.

Once the P2P group is determined as a temporary group, in the case where the P2P group determined as a temporary group is formed again, devices belonging to the P2P group may need to perform procedures required for forming the P2P group again.

Once the P2P group is determined as a persistent group, in the case where the P2P group determined as a persistent group is formed again, devices belonging to the P2P group may omit procedures required for forming the P2P group, making it possible to form the P2P group rapidly. At this time, as the P2P group is determined as a persistent group, devices belonging to the P2P group may store authentication information required to form the P2P group in the memory of each of the devices. At this time, the stored information may be referred to as P2P persistent group profile information.

In detail, the electronic device 100 may receive authentication information for forming the P2P group with the external device 200. At this time, the authentication information may include a network key for generating an encryption key. Each of the electronic device 100 and the external devices 200 may exchange encryption keys generated by using the network key, and identify whether the exchanged keys are matched, to form the P2P group.

Herein, the type of network key for satisfying a security protocol based on a communication frequency of the P2P group may vary. For example, in the case where a first communication frequency of the P2P group is 2.4 GHz or 5 GHz, the type of network key for satisfying a security protocol of the P2P group may be a pre-shared key (PSK). Additionally, in the case where a second communication frequency of the P2P group is 6 GHz, the type of network key for satisfying a security protocol of the P2P group may be a passphrase.

In detail, the security protocol may vary depending on a communication standard used at a time when the P2P group is formed. For example, in the case of a communication standard of Wi-Fi 5 using a communication frequency of 2.4 GHz or 5 GHz, a WPA2 security protocol may be used to perform an authentication process. Additionally, in the case of a communication standard of WiFi6 using a communication frequency of 6 GHz, a WPA3 security protocol may be used to perform an authentication process.

At this time, a network key type used in the authentication process in which the WPA2 security protocol is used may be a pre-shared key (PSK). Herein, the PSK may mean an encryption key shared previously between devices for performing the P2P group.

Alternatively, in the case of a communication standard of WiFi6 using a communication frequency of 6 GHz, the WPA3 security protocol may be forcibly used. In other words, in the case where the P2P group is formed based on the WiFi6 communication standard, the WPA3 security protocol may be used to perform the authentication process.

At this time, a network key type used in the authentication process in which the WPA3 security protocol is used may be a passphrase. Herein, the passphrase may mean a password input by the user to a device. In other words, the WPA3 security protocol using a passphrase may provide more reliable security than the WPA2 communication standard using a PSK.

Accordingly, to form the P2P group through the first communication frequency, the electronic device 100 may receive first authentication information from the external device 200.

Additionally, once the P2P group is determined as a persistent group, the electronic device 100 may store the first authentication information for forming the P2P group with the external device 100 in the P2P persistent group profile information.

In the case where the P2P groups is ungrouped and then is formed again, when the electronic device 100 attempts to form the P2P group with the external device 200 through the second communication frequency by using the first authentication information included in the P2P persistent group profile information, the first authentication information may not satisfy the security protocol based on the second communication frequency, thereby failing to form the P2P group. At this time, the electronic device 100 may need to perform the provisioning operation again with the external device to form the P2P group with the external device 200 through the second communication frequency.

For example, the first communication frequency may be 2.4 GHz or 5 GHz. Additionally, the second communication frequency may be 6 GHz. At this time, to form the P2P group based on a communication standard of Wi-Fi 5 using the 2.4 GHz or 5 GHz communication frequency, the electronic device 100 may receive first authentication information including a PSK-type network key for performing authentication based on a WPA2 security protocol. Additionally, the electronic device 100 may store the received first authentication information in P2P group profile information. Then, in the process of forming the P2P group again based on a communication standard of WiFi6 using a 6 GHz communication frequency, the electronic device 100 may not perform authentication based on the WPA3 security protocol by using the first authentication information stored in the P2P group profile information, thereby failing to form the P2P group.

Alternatively, the first communication frequency may be 6 GHz, while the second communication frequency is 2.4 GHz or 5 GHz. At this time, to form the P2P group based on the communication standard of WiFi6 using the 6 GHz communication frequency, the electronic device 100 may receive first authentication information including a passphrase-type network key for performing authentication based on the WPA3 security protocol. Additionally, the electronic device 100 may store the received first authentication information in the P2P group profile information. Then, in the process of forming the P2P group based on a communication standard of Wi-Fi 5 using a 2.4 GHz or 5 GHz communication frequency, the electronic device 100 may not perform authentication based on the WPA2 security protocol by using the first authentication information included in the P2P group profile information, thereby failing to form the P2P group again.

To solve the above problem, the electronic device 100 according to the disclosure may receive, from the external device 200, the first authentication information for forming the P2P group with the external device 200 through the first communication frequency together with the second authentication information for forming the P2P group with the external device 200 through the second communication frequency, while forming the P2P group with the external device 200 through the first communication frequency.

For example, while forming the P2P group based on the Wi-Fi 5 communication standard, the electronic device 100 may receive, from the external device 200, the first authentication information including a PSK-type network key for performing authentication based on the WPA2 security protocol corresponding to the Wi-Fi 5 communication standard and the second authentication information including a passphrase-type network key corresponding to the WiFi6 communication standard.

Alternatively, while forming the P2P group based on the WiFi6 communication standard, the electronic device 100 may receive, from the external device 200, the first authentication information including a passphrase-type network key for performing authentication based on the WPA3 security protocol corresponding to the WiFi6 communication standard and the second authentication information including a PSK-type network key for performing authentication based on the WPA2 security protocol corresponding to the Wi-Fi 5 communication standard.

Additionally, in the case where an attribute of the P2P group is in a persistent group, the electronic device 100 may store, in the memory 110, P2P persistent group profile information 111 including the received first authentication information and the received second authentication information.

Further, in the case where after the P2P persistent group between the electronic device 100 and the external device 200 is ungrouped, a P2P persistent group between the electronic device 100 and the external device 200 is requested to be formed again, the electronic device 100 may form the P2P group again with the external device 200 by using the P2P persistent group profile information 111.

In other words, in the case where the electronic device 100 attempts to for the P2P group again with the external device 200 through the first communication frequency, the electronic device 100 may omit a provisioning operation for forming the P2P group again with the external device 200, and form the P2P group again with the external device 200 through the first communication frequency by using the first authentication information out of the first authentication information and the second authentication information included in the P2P persistent group profile information 111.

Additionally, in the case where the electronic device 100 attempts to form the P2P group again with the external device 200 through the second communication frequency, the electronic device 100 omit a provisioning operation for forming the P2P group again with the external device 200, and form the P2P group again with the external device 200 through the second communication frequency by using the second authentication information out of the first authentication information and the second authentication information included in the P2P group profile information 111.

For example, as the P2P group is formed for the first time based on the Wi-Fi 5 communication standard, first authentication information including a PSK-type network key for performing authentication based on the WPA2 security protocol corresponding to the Wi-Fi 5 communication standard and second authentication information including a passphrase-type network key corresponding to the WiFi6 communication standard may be stored in the memory 110. At this time, as an event for forming the P2P group again based on the WiFi6 communication standard is detected, the electronic device 100 may form the P2P group again by using the second authentication information.

Alternatively, as the P2P group is formed for the first time based on the WiFi6 communication standard, first authentication information including a PSK-type network key for performing authentication based on the WPA2 security protocol corresponding to the Wi-Fi 5 communication standard and second authentication information including a passphrase-type network key corresponding to the WiFi6 communication standard may be stored in the memory 110. At this time, as an event for forming the P2P group again based on the Wi-Fi 5 communication standard is detected, the electronic device 100 may form the P2P group again by using the first authentication information.

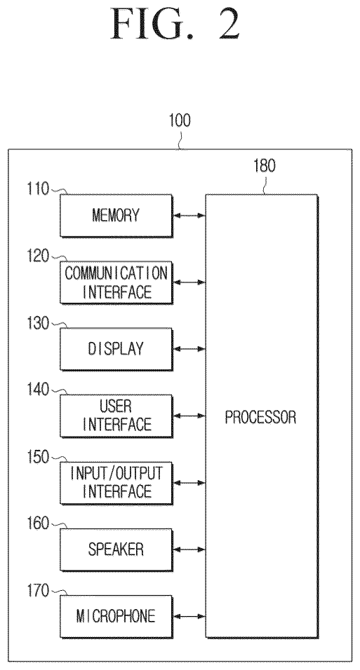

FIG. 2 is a block diagram provided to explain a configuration of an electronic device 100 according to one or more embodiments.

The electronic device 100 may include memory 110, a communication interface 120, a display 130, a user interface 140, an input/output interface 150, a speaker 160, a microphone 170 and a processor 180. As for the electronic device 100, part of the above elements may be omitted, and another element may be further included.

Additionally, the electronic device 100 may be implemented as a TV, but this is described merely as one embodiment, and the electronic device 100 may be implemented in various different types such as a smartphone, a smart TV, a set-top box, a mobile phone, a server, a personal digital assistant (PDA), a laptop, a media player, an e-book reader, a terminal for digital broadcasting, a navigator, a kiosk, an MP3 player, a wearable device, a home appliance and another mobile or a non-mobile computing device and the like.

The memory 110 may store at least one instruction associated with the electronic device 100. The memory 110 may store an operating system (O/S) for driving the electronic device 100. Additionally, the memory 110 may store various types of software programs or applications for the electronic device 100 to operate according to various embodiments of the disclosure. Further, the memory 110 may include semiconductor memory such as flash memory and the like or a magnetic storage medium such as a hard disk and the like, and the like.

Specifically, the memory 110 may store various types of software modules for the electronic device 100 to operate according to various embodiments of the disclosure, and the processor 180 may control operations of the electronic device 100 by executing various types of software modules stored in the memory 110. That is, the memory 110 may be accessed by the processor 180, and reading/storing/correcting/deleting/updating and the like of data in the memory 110 may be performed by the processor 180.

Meanwhile, in the disclosure, the term memory 110 may be used in the way that the term memory 110 has a meaning including memory 110, ROM (not illustrated) or RAM (not illustrated) in the processor 180, or a memory card (not illustrated; e.g., a micro SD card, a memory stick) mounted in the electronic device 100.

Additionally, the communication interface 120 includes circuitry, and is an element communicable with an external device and a server. The communication interface 120 may perform communication with an external apparatus or a server based on a wired or wireless communication method. The communication interface 120 may include a Bluetooth module (not illustrated), a Wi-Fi module (not illustrated), an infrared (IR) module, a local area network (LAN) module, an Ethernet module and the like. Herein, each of the communication modules may be implemented in the form of at least one hardware chip. A wireless communication module may include at least one communication chip such as ZigBee, Universal Serial Bus (USB), Mobile Industry Processor Interface Camera Serial Interface (MIPI CSI), 3rd Generation (3G), 3rd Generation Partnership Project (3GPP), Long Term Evolution (LTE), LTE Advanced (LTE-A), 4th Generation (4G), 5th Generation (5G) and the like that perform communication according to various wireless communication standards in addition to the above-described communication methods. However, these are described merely as one embodiment, and the communication interface 120 may use at least one communication module among various types of communication modules.

The communication interface 120 may form a peer-to-peer (P2P) connection with the external device 200. Herein, the external device 200 may be a smartphone, but this is described merely as one embodiment, and the external device 200 may be implemented in various different types such as a TV, a smart TV, a set-top box, a mobile phone, a server, a personal digital assistant (PDA), a laptop, a media player, an e-book reader, a terminal for digital broadcasting, a navigator, a kiosk, an MP3 player, a wearable device, a home appliance and another mobile or a non-mobile computing device and the like.

The display 130 may be implemented as various types of displays such as a liquid crystal display (LCD), an organic light emitting diode (OLED) display, a plasma display panel (PDP) display and the like. In the display 130, driving circuitry implementable in the form of an amorphous silicon thin film transistor (a-si TFT), a low temperature poly silicon (LTPS) TFT, an organic TFT (OTFT) and the like, a backlight unit and the like may be included together. Meanwhile, the display 130 may be implemented as a touch screen coupled with a touch sensor, a flexible display, a three-dimensional (3D) display and the like.

According to the embodiments, the electronic device 100 may not include a display 130. The electronic device 100 may be connected with an external display device, and may transmit an image or a content stored in the electronic device 100 to the external display device. In detail, the electronic device 100 may transmit, to the external display device, an image or a content together with a control signal for controlling to display the image or content on the external display device. Herein, the external display device may be connected with the electronic device 100 through the communication interface 120 or the input/output interface 150. For example, the electronic device 100 may not include a display, like a set-top box (STB). Additionally, the electronic device 100 may include only a small-sized display capable of displaying only simple information such as text information and the like. Herein, the electronic device 100 may transmit an image or a content to an external display device through the communication interface 120 in a wired or wireless manner or transmit an image or a content to an external display device through the input/output interface 150.

The user interface 140 may be implemented as a device such as a button, a touch pad, a mouse and a keyboard, or as touch screen capable of performing a manipulation input function as well as the above-described display function. Herein, the button may be various types of buttons such as a mechanical button, a touch pad, a wheel and the like that are formed in any area of the front, side, rear and the like of the exterior of the main body of the electronic device 100.

The input/output interface 150 may be any one interface among High-Definition Multimedia Interface (HDMI), Mobile High-Definition Link (MHL), Universal Serial Bus (USB), Display Port (DP), Thunderbolt, a Video Graphics Array (VGA) port, an RGB port, D-subminiature (D-SUB), and Digital Visual Interface (DVI). The input/output interface 150 may input and output at least one of an audio signal and a video signal. Depending on embodiments, the input/output interface 150 may include a port inputting and outputting an audio signal only, and a port inputting and outputting a video signal only as separate ports, or may be implemented as one port inputting and outputting both of the audio signal and the video signal. Meanwhile, the electronic device 100 may transmit at least one of the audio and video signals to an external device (e.g., an external display device or an external speaker) through the input/output interface 150. In detail, an output port included in the input/output interface 150 may be connected with an external device, and the electronic device 100 may transmit at least one of the audio and video signals to the external device through the output port.

Herein, the input/output interface 150 may be connected with the communication interface 120. The input/output interface 150 may transmit information received from an external device to the communication interface 120 or transmit information received through the communication interface 120 to the external device.

The speaker 160 is an element outputting an audio signal. In particular, the speaker 160 may include an audio output mixer, an audio signal processor, a sound output module. The audio output mixer may synthesize a plurality of audio signals to be output into at least one audio signal. For example, the audio output mixer may synthesize an analogue audio signal and another analogue audio signal (e.g., an analogue audio signal received from the outside) into at least one analogue audio signal. The sound output module may include a speaker or an output terminal. According to various embodiments, the sound output module may include a plurality of speakers, and in this case, the sound output module may be disposed in a main body, and a sound released while covering at least part of a vibration plate of the sound output module may be delivered to the outside of the main body by passing through a waveguide. The sound output module may include a plurality of sound output units, and since the plurality of sound output units is disposed to be symmetrical to the exterior of the main body, the plurality of sound output units may release a sound in all direction, i.e., at 360 degrees. Additionally, the speaker 160 may be an element outputting various types of notification sounds or voice messages and the like as well as various types of audio data.

The microphone 170 is an element for receiving an input of a user voice or other sounds, and converting the same to audio data. The microphone 170 may receive a user voice in an activated state. For example, the microphone 170 may be integrally formed on an upper side or in a front surface direction, in a lateral surface direction and the like of the electronic device 100. The microphone 170 may include various types of elements such as a microphone collecting a user voice in an analogue form, amp circuitry amplifying the collected user voice, A/D conversion circuitry sampling the amplified user voice and converting the same to a digital signal, and filter circuitry removing a noise component from the converted digital signal, and the like.

Additionally, the electronic device 100 may obtain a user voice through the microphone 170 included in the electronic device 100. Alternatively, the electronic device 100 may obtain a user voice from an external device provided with a microphone. In detail, the microphone may be provided to a separate external device such as a remote controller, a smartphone, a speaker and the like that transmit a signal to the electronic device 100. Herein, the microphone provided to the external device may digitalize an analogue voice signal, and the electronic device 100 may perform a communication connection with the external device through the communication interface 120 to receive the digitalized voice signal.

At this time, a remote controller application may be installed in the external device. Additionally, the external device may control the electronic device 100 through the remote controller application, and perform a user voice recognition function. At this time, the external device may perform communication with the electronic device 100 and a server through a plurality of communication interfaces.

Further, the external device in which the remote controller application is installed may be a smartphone, but this is described merely as one embodiment, and the external device may be implemented through various types of devices such as an AI speaker and the like in which an application is installable.

Furthermore, the electronic device 100 may be connected with the external device in a wired/wireless manner through the communication interface 120 or the input/output interface 150, and the electronic device 100 may receive an audio signal with respect to a user voice from the external device.

The processor 180 may control entire operations and functions of the electronic device 100. In detail, the processor 180 may be connected to the configuration of the electronic device 100 including the memory 110, and may control entire operations of the electronic device 100 by executing at least one instruction stored in the memory 110 as described above.

The processor 180 may be implemented in various ways. For example, the processor 180 may be implemented as at least one of an application specific integrated circuit (ASIC), a logic integrated circuit, an embedded processor, a microprocessor, hardware control logic, a hardware finite state machine (FSM), and a digital signal processor (DSP). Meanwhile, the term processor 180 in the disclosure may be used in the way that the term processor 180 has a meaning including a central processing unit (CPU), a graphic processing unit (GPU), and a main processing unit (MPU0 and the like.

In particular, the processor 180 may include one or more processors. In detail, the one or more processors may include one or more of a central processing unit (CPU), a graphics processing unit (GPU), an accelerated processing unit (APU), Many Integrated Core (MIC), a digital signal processor (DSP), a neural processing unit (NPU), a hardware accelerator or a machine learning accelerator. The one or more processors may control one among other elements of the electronic device or any combination thereof, and perform an operation associated with communication or data processing. The one or more processors may execute one or more programs or instructions stored in the memory. For example, the one or more processors may perform a method according to one embodiment by executing the one or more instructions stored in the memory.

In the case where a method according to one or more embodiments of the disclosure includes a plurality of operations, the plurality of operations may be performed by one processor, or by a plurality of processors. That is, when a first operation, a second operation, and a third operation are performed based on a method according to one embodiment, the first operation, the second operation and the third operation may all be performed by a first processor, or the first operation and the second operation may be performed by the first processor (e.g., a generic-purpose processor), while the third operation may be performed by a second processor (e.g., an AI-exclusive processor).

The one or more processors may be implemented as a single core processor including one core, or one or more multicore processors including a plurality of cores (e.g., a homogeneous multi core or a heterogeneous multi core). In the case where the one or more processors are implemented as a multicore processor, each of the plurality of cores included in the multicore processor may include a processor internal memory such as cache memory, and on-chip memory, and common cache shared by the plurality of cores may be included in the multicore processor. Additionally, each of the plurality of cores (or part of the plurality of cores) included in the multicore processor may read and perform a program instruction for implementing the method according to one or more embodiments of the disclosure independently, or in the way that all (or part) of the plurality of cores are linked.

In the case where the method according to one or more embodiments of the disclosure includes a plurality of operations, the plurality of operations may be performed by one of the plurality of cores included in the multicore processor, or by the plurality of cores included in the multicore processor. For example, when a first operation, a second operation, and a third operation are performed based on a method according one embodiment, the first operation, the second operation and the third operation may all be performed by a first core included in the multicore processor, or the first operation and the second operation may be performed by the first core included in the multicore processor, while the third operation may be performed by a second core included in the multicore processor.

In the embodiments of the disclosure, the processor 180 may denote a system on a chip (SoC) where one or more processors and other electronic parts are integrated, a single core processor, a multicore processor, or a core included in a single core processor or a multicore processor, and herein, the core may be implemented as a CPU, a GPU, an APU, a MIC, a DSP, an NPU, a hardware accelerator, or a machine learning accelerator and the like, but the embodiment thereof may not be limited thereto.

Operations of the processor 180 for implementing the embodiments of the disclosure may be implemented through a plurality of modules.

In detail, data associated with the plurality of modules according to the disclosure may be stored in the memory 110, and the processor 180 may access the memory 110 and load data on the plurality of modules to memory or a buffer in the processor 180, and then implement the embodiments of the disclosure by using the plurality of modules.

However, at least one of the plurality of modules according to the disclosure may be implemented as hardware, and in the form of a system on a chip, may be included in the processor 180.

Alternatively, at least one of the plurality of modules according to the disclosure may be implemented as a separate external device, and the electronic device 100 and each of the modules may perform the operations according to the disclosure while performing communication.

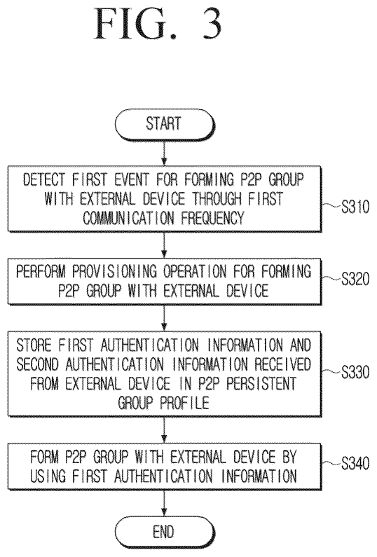

FIG. 3 is a view provided to explain a method by which an electronic device performs a provisioning operation for forming a P2P group according to one or more embodiments.

Referring to FIG. 3, the processor 180 may detect a first event for forming a P2P group with the external device 200 (S310).

Herein, the first event for forming a P2P group with the external device 200 through a first communication frequency may be an event in which a user input for forming a P2P group with the external device 200 is obtained.

Alternatively, the first event for forming a P2P group with the external device 200 may be an event in which a user input for forming a P2P group with the external device 200 through a first communication frequency is obtained. At this time, the first communication frequency for forming a P2P group may be a communication frequency input by the user.

Alternatively, the first event for forming a P2P group with the external device 200 may be an event in which a user input for forming a P2P group with the external device is obtained in the state where the electronic device 100 is connected with an access point (AP) through the first communication frequency.

Alternatively, the first event for forming a P2P group with the external device 200 may be an event in which the electronic device 100 receives a request to form a P2P group from the external device 200 through the first communication frequency.

As the event for forming a P2P group with the external device 200 through the first communication frequency is detected, the processor 180 may perform a provisioning operation for forming a P2P group with the external device 200 (S320).

At this time, the electronic device 100 and the external device 200 may exchange messages for determining a group owner device forming a P2P group. At this time, the exchanged messages may include an Intent value of a Go Intent field. Additionally, the processor 180 may compare an Intent value of the electronic device 100 and an Intent value of the external device to determine a device of a higher Intent value of the two as a group owner device. Further, the processor 180 may determine a device of a lower Intent value of the two as a client device. At this time, an attribute of a P2P group may be determined as a temporary group or a persistent group. The attribute of a P2P group is described with reference to FIG. 1, and accordingly, repetitive descriptions thereof are omitted.

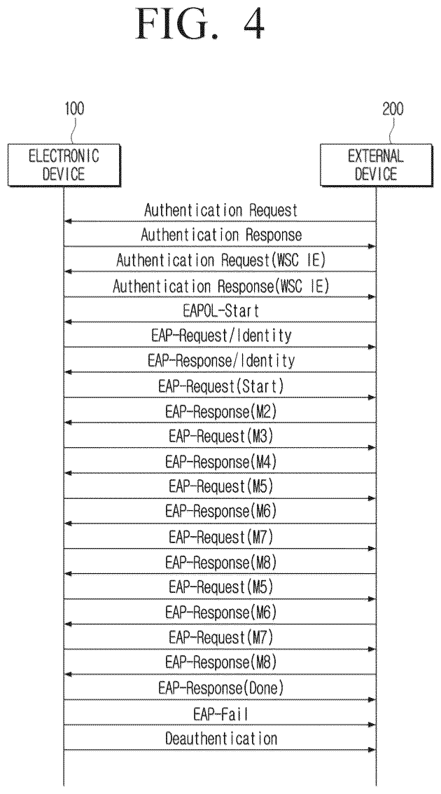

Referring to FIG. 4, in the case where the electronic device 100 is determined as a client device, the processor 180 may transceive a request signal and a response signal to perform a provisioning operation with the external device 200.

Herein, the processor 180 may transceive a message (M1-M8) for performing a provisioning operation with the external device 200.

At this time, the processor 180 may identify the first communication frequency for forming a P2P group with the external device 200. In detail, the processor 180 may receive, from the external device 200, information on a communication frequency supportable by the external device 200 or AP connection information of the external device 200. At this time, the processor 180 may identify a communication frequency of a high frequency among communication frequencies supportable by the external device 200 as the first communication frequency. Alternatively, the processor 180 may identify a communication frequency at which the external device 200 is connected with the AP as the first communication frequency forming a P2P group. Alternatively, the processor 180 may identify a communication frequency at which the electronic device 100 is connected with the AP as the first communication frequency for forming a P2P group. Alternatively, the processor 180 may identify a communication frequency set by the user as the first communication frequency.

Meanwhile, the processor 180 may identify the first communication frequency for forming a P2P group, but this is described merely as one embodiment, and the first communication frequency for forming a P2P group may be determined by the external device 200.

Additionally, the processor 180 may receive message M8 including authentication information for forming a P2P group with the external device 200. At this time, the authentication information for forming a P2P group with the external device 200 may include first authentication information for forming a P2P group with the external device 200 through a first communication frequency, and second authentication information for forming a P2P group with the external device 200 through a second communication frequency.

The first authentication information may include information on a first network key, and the second authentication information may include information on a second network key. In detail, the message M8 may include the information on a first network key corresponding to the first authentication information and the information on a second network key corresponding to the second authentication information.

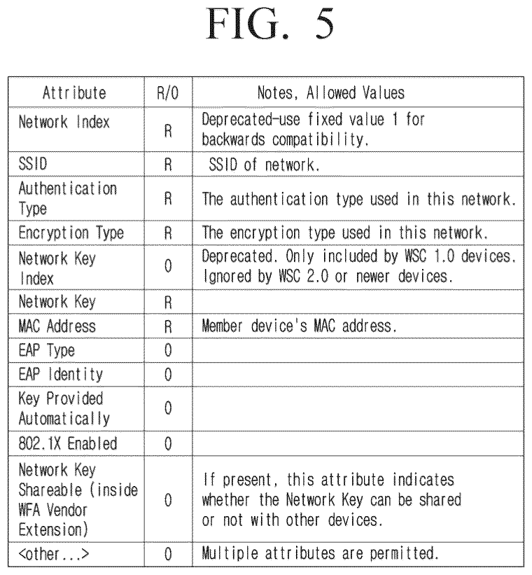

In detail, attributes included in the message M8 may be the same as those illustrated in FIG. 5. At this time, each of the attributes of the message M8 may be expressed in a type-length-value (TLV) form.

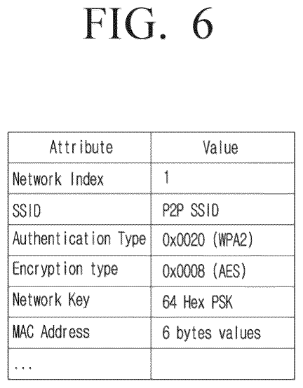

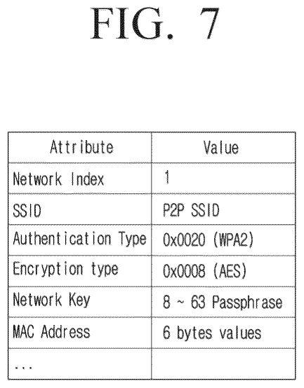

At this time, values with respect to network key attributes among the attributes of the message M8 are the same as those illustrated in FIGS. 6 and 7.

Referring to FIG. 6, the first network key may be a pre-shared key (PSK)-type network key. In detail, the first network key may be a pre-shared key (PSK)-type network key comprised of a 64-digit hexadecimal number. Additionally, an authentication type of the first network key may be WPA2, and an encryption type of the first network key may be AES. Further, attributes of the first network key may include MAC address information of the external device 200 connectable by using the first network key.

Additionally, referring to FIG. 7, the second network key may be a passphrase-type network key. In detail, the second network key may be a passphrase-type network key formed into an ASCII string of a minimum length of 8 characters and a maximum length of 63 characters. Further, an authentication type of the second network key may be WPA2, and an encryption type of the second network key may be AES. Further, attributes of the second network key may include MAC address information of the external device 200 connectable by using the second network key.

Meanwhile, the first network key may be a PSK-type network key, while the second network key may be a passphrase-type key, but these are described merely as one embodiment, and the first network key may be a passphrase-type key, while the second network key may be a PSK-type key.

Based on the first authentication information and the second authentication information being received, the processor 180 may store the first authentication information and the second authentication information in P2P persistent group profile information (S330). At this time, a P2P persistent group profile may be stored in the memory 110.

Additionally, the processor 180 may form a P2P group with the external device 200 by using the first authentication information (S340). For example, the processor 180 may generate an encryption key such as a group temporal key (GTK) by using the first network key included in the first authentication information, transmit the generate encryption key to the external device 200, and receive, from the external device 200, an encryption key generated by the external device 200 by using the first network key. At this time, based on the transmitted encryption key and the received encryption key being matched, the processor 180 may form a P2P group with the external device 200.

Meanwhile, the electronic device 100, as described above, may be determined as a client device in the process of forming a P2P group, but this is described merely as one embodiment, and the electronic device 100 may be determined as an owner device. In the case where the electronic device 100 is determined as an owner device, the electronic device 100 may transmit message M8 including first authentication information and second authentication information to the external device 200. Accordingly, the external device 200 may store the first authentication information and the second authentication information in the memory of the external device 200, and then based on an event for forming a P2P group between the electronic device 100 and the external device 200 being detected, the external device 200 may form a P2P group with the electronic device 100, through a first communication frequency or a second communication frequency, by using the authentication information stored in the memory of the external device 200.

Meanwhile, as described above, the first communication frequency may be determined as a communication frequency for forming a P2P group between the electronic device 100 and the external device 200, and the electronic device 100 may receive the message M8 including the first authentication information and the second authentication information, store the first authentication information and the second authentication information in the memory 110, and form a P2P group with the external device 200, through the first communication frequency, by using the first authentication information, but this is described merely as one embodiment and is not limited thereto. According to one or more embodiments, the second communication frequency may be determined as a communication frequency for forming a P2P group between the electronic device 100 and the external device 200, and the electronic device 100 may receive message M8 including first authentication information and second authentication information, store the first authentication information and the second authentication information in the memory 110, and form a P2P group with the external device 200, through the second communication frequency, by using the second authentication information.

Meanwhile, based on the first authentication information and the second authentication information being stored in the memory 110, and an event for forming a P2P group again with the external device 200 being detected, the electronic device 100 may form a P2P group again the external device 200 by using P2P group profile information stored in the memory 110, without performing a provisioning operation for forming a P2P group again with the external device 200.

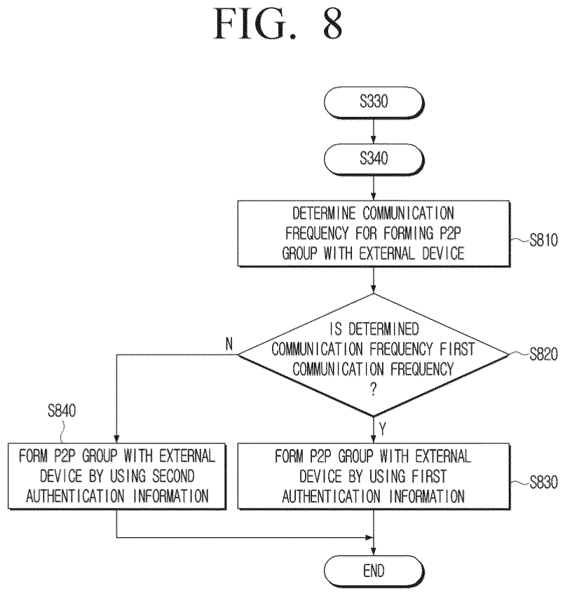

FIG. 8 is a flowchart provided to explain a method by which an electronic device forms a P2P group with an external device 200 by using authentication information stored in memory according to one or more embodiments.

The processor 180 may store, in P2P persistent group profile information, the first authentication information and the second authentication information received from the external device 200 (S330).

Additionally, the processor 180 may detect an event for forming a P2P group again with the external device 200. Based on the event for forming a P2P group again with the external device 200 being detected, the processor 180 may transmit a request signal of forming a P2P group again to the external device 200, and receive a response signal with respect to a request to form a P2P group again from the external device 200.

Additionally, the processor 180 may identify a communication frequency for forming a P2P group again with the external device 200. In other words, the processor 180 may determine whether the communication frequency for forming a P2P group with the external device 200 is a first communication frequency (S820).

At this time, the operation in which the processor 180 identifies a communication frequency for forming a P2P group with the external device 200 may be the same as the above-described operation.

Based on the communication frequency for forming a P2P group with the external device 200 being a first communication frequency (S820—Y), the processor 180 may form a P2P group with the external device 200 through the first communication frequency by using the first authentication information stored in the P2P group profile information (S830).

Further, based on the communication frequency for forming a P2P group with the external device 200 being a second communication frequency (S820—N), the processor 180 may form a P2P group with the external device 200 through the second communication frequency by using the second authentication information stored in the P2P group profile information (840).

Meanwhile, the term “unit” or “module” set forth herein may include a unit comprised of hardware, software or firmware, and for example, may be used interchangeably with terms such as a logic, a logical block, a part, or a circuit and the like. The term “unit” or “module” may denote an integrally constituted part, or a minimum unit or a part thereof performing one or more functions. For example, a module may be comprised of an application-specific integrated circuit (ASIC).

The embodiments set forth herein may be implemented with software including instructions stored in a storage medium readable by a machine (e.g., a computer). The machine, as a device capable of calling the stored instructions from the storage medium and operating according to the called instructions, may include the electronic device 100 according to the disclosed embodiments. Based on the instructions being executed by a processor, the processor may perform functions corresponding to the instructions directly or by using other elements under the control of the processor. The instructions may include a code generated or executed by a compiler or an interpreter. The machine-readable storage medium may be provided in the form of a non-transitory storage medium. Herein, the wording “non-transitory” only means that a storage medium includes no signal and is tangible, while the wording does distinguish semi-permanent or temporary storage of data in the storage medium.

According to the embodiments set forth herein, the method may be provided in a computer program product. The computer program product may be exchanged between a seller and a purchaser as a commodity. The computer program product may be distributed in the form of a machine-readable storage medium (e.g., compact disc read only memory (CD-ROM)) or distributed online through an application store (e.g., Play Store™). In the case of online distribution, at least part of the computer program product may be stored at least temporarily, or generated temporarily in a storage medium such as a manufacturer's server, a server of an application store, or memory of a relay server.

Further, each of the elements (e.g., a module or a program) according to the embodiments may be comprised of a single entity or a plurality of entities, and some of the corresponding sub elements described above may be omitted, or another sub element may be further included in the embodiments. Alternatively or additionally, some of the elements (e.g., modules or programs) may be integrated into one entity to perform functions performed by each corresponding element prior to integration in an identical or similar manner. Operations performed by a module, a program, or another element, according to the embodiments, may be executed sequentially, in parallel, repetitively, or heuristically, or at least part of the operations may be executed in a different order, omitted, or may include another operation.

1. An electronic device comprising:
a communication interface;
a memory to store at least one instruction; and
a processor to connected with the memory to control the electronic device, the processor configured to:
receive, from an external device, based on a first event to form a P2P group with the external device through a first communication frequency being detected, first authentication information to form the P2P group through the first communication frequency and second authentication information to form the P2P group through a second communication frequency,
form the P2P group through the first communication frequency by using the first authentication information, and
form, based on a second event to form the P2P group with the external device through a second communication frequency being detected, the P2P group through the second communication frequency by using the second authentication information received based on the first event.

2. The electronic device of claim 1,
wherein the processor:
controls, based on the electronic device being connected with an access point (AP) through the first communication frequency, the electronic device such that the electronic device and the external device form the P2P group through the first communication frequency by using the first authentication information, and
controls, based on the electronic device being connected with the AP through the second communication frequency, the electronic device such that the electronic device and the external device form the P2P group through the second communication frequency by using the second authentication information.

3. The electronic device of claim 1,
wherein the first communication frequency is 2.4 GHz or 5 GHz, and
the second communication frequency is 6 GHz.

4. The electronic device of claim 1,
wherein the first authentication information includes pre-shared key-type information, and
the second authentication information includes passphrase-type information.

5. The electronic device of claim 4,
wherein the processor:
transmits an encryption key generated by using the first authentication information to the external device, to form a P2P group with the external device through the first communication frequency, and
transmits an encryption key generated by using the second authentication information to the external device, to form a P2P group with the external device through the second communication frequency.

6. The electronic device of claim 1,
wherein the processor:
identifies, based on information on a communication frequency at which the external device is connected with an AP, a communication frequency to form a P2P group with the external device.

7. The electronic device of claim 1,
wherein the processor:
identifies, based on information associated with a current communication frequency at which the external device is connected with an AP, a candidate communication frequency to form a P2P group with the external device.

8. A control method of an electronic device, the control method comprising:
receiving from an external device, based on a first event to form a P2P group with the external device through a first communication frequency being detected, first authentication information to form the P2P group through the first communication frequency and second authentication information to form the P2P group through a second communication frequency, from the external device;
forming the P2P group through the first communication frequency by using the first authentication information; and
forming, based on a second event to form the P2P group with the external device through the second communication frequency being detected, the P2P group through the second communication frequency by using the second authentication information received based on the first event.

9. The control method of claim 8 comprising:
controlling, based on the electronic device being connected with an access point (AP) through the first communication frequency, the electronic device such that the electronic device and the external device form the P2P group through the first communication frequency by using the first authentication information, and
controlling, based on the electronic device being connected with the AP through the second communication frequency, the electronic device such that the electronic device and the external device form the P2P group through the second communication frequency by using the second authentication information.

10. The control method of claim 8,
wherein the first communication frequency is 2.4 GHz or 5 GHz, and
the second communication frequency is 6 GHz.

11. The control method of claim 8,
wherein the first authentication information includes pre-shared key-type information, and
the second authentication information includes passphrase-type information.

12. The control method of claim 11 further comprising:
transmitting an encryption key generated by using the first authentication information to the external device, to form a P2P group with the external device through the first communication frequency; and
transmitting an encryption key generated by using the second authentication information to the external device, to form a P2P group with the external device through the second communication frequency.

13. The control method of claim 8 further comprising:
identifying, based on information on a communication frequency at which the external device is connected with an AP, a communication frequency to form a P2P group with the external device.

14. The control method of claim 8 further comprising:
identifying, based on information on a current communication frequency at which the external device is connected with an AP, a candidate communication frequency to form a P2P group with the external device.

15. A non-transitory computer-readable recording medium including a program that executes a control method of an electronic device, the control method comprising:
receiving from an external device, based on a first event to form a P2P group with the external device through a first communication frequency being detected, first authentication information to form the P2P group through the first communication frequency and second authentication information to form the P2P group through a second communication frequency;
forming the P2P group through the first communication frequency by using the first authentication information; and
forming, based on an event to form the P2P group with the external device through the second communication frequency being detected, the P2P group through the second communication frequency by using the second authentication information received based on the first event.
